(19) United States
(12) Patent Application Publication
(10) Pub. No.: US 2011/0246796 A1
(43) Pub. Date: Oct. 6, 2011

(54) ELECTRONIC APPARATUS AND POWER CONTROL METHOD

(75) Inventor: Kenji KOMORI, Oume-shi (JP)

(73) Assignee: KABUSHIKI KAISHA TOSHIBA, Tokyo (JP)

(21) Appl. No.: 13/077,729

(22) Filed: Mar. 31, 2011

(30) Foreign Application Priority Data
Mar. 31, 2010 (JP) 2010-084351
Sep. 30, 2010 (JP) 2010-222520

(51) Int. Cl. G06F 1/26

(52) U.S. Cl. 713/300

(57) ABSTRACT

According to one embodiment, an electronic apparatus includes: a first and second ports each having: a data line configured to perform a signal reception to receive a signal corresponding to at least one of video and audio; and a power line configured to perform a power supply; and a controller configured to perform, upon a physical connection of a first electronic device to the first port, the signal reception from the first electronic device and the power supply to the first electronic device, and to perform, upon a physical connection of a second electronic device to the second port in addition to the physical connection of the first electronic device to the first port, the power supply to the second electronic device without performing the signal reception from the second electronic device.

### CROSS-REFERENCE TO RELATED APPLICATION(S)

This application is based upon and claims the benefit of priorities from Japanese Patent Application No. 2010-084351, filed on Mar. 31, 2010, and from Japanese Patent Application No. 2010-222520, filed on Sep. 30, 2010, the entire contents of which are incorporated herein by reference.

### FIELD

Embodiments described herein relate generally to an electronic apparatus and a power control method.

### BACKGROUND

In recent years, sometimes, plural audio-visual (AV) apparatuses are used while being connected to each other via a bidirectional interface such as HDMI (high-definition multimedia interface). For example, through a bidirectional interface, a content reproduced by a digital video recorder or the like can be output to a display apparatus therethrough. Further, through such bidirectional interface, apparatuses can be operated in link with each other therethrough (for example, refer to JP-2003-087671-A).

In some interface standards for connection of AV apparatuses, a sink apparatus (which displays video) supplies power to a source apparatus (which reproduces video), in parallel with transmission of a signal corresponding to video and/or audio. In an interface compatible with such a standard, a sink apparatus can charge a source apparatus when the source apparatus is logically connected with the sink apparatus to output a signal corresponding to video and/or audio.

However, in an interface standard where number of logically-connectable source apparatuses is limited, sometimes, when a logical connection is not established between the source apparatus and the sink apparatus, the source apparatus can not be charged even if a physical connection (by a cable) is established. Generally, as the function of AV apparatus is improved, the power consumption thereof increases. For a battery-driven portable AV apparatus, a charging-friendly environment is required, and it is preferable to charge the source apparatus regardless of the number of logically-connectable source apparatuses in the standard.

### BRIEF DESCRIPTION OF THE DRAWINGS

A general architecture that implements the various feature of the present invention will now be described with reference to the drawings. The drawings and the associated descriptions are provided to illustrate embodiments of the present invention and not to limit the scope of the present invention.

FIG. 1 illustrates a signal transmission system according to the embodiment.

FIG. 2 illustrates a block diagram of the signal transmission system according to the embodiment.

FIG. 3 illustrates a power control according to the embodiment.

FIG. 4 illustrates an example of an external input switching picture used in the embodiment.

FIG. 5 illustrates a processing flow of a power control process according to the embodiment.

### DETAILED DESCRIPTION

In general, according to one embodiment, there is provided an electronic apparatus, including: a first port and a second port each having: a data line configured to perform a signal reception to receive a signal corresponding to at least one of video and audio, therethrough; and a power line configured to perform a power supply, therethrough; and a controller configured to perform, upon a physical connection of a first electronic device to the first port, the signal reception from the first electronic device and the power supply to the first electronic device through the power line of the first port, and to perform, upon a physical connection of a second electronic device to the second port in addition to the physical connection of the first electronic device to the first port, the power supply to the second electronic device through the power line of the second port without performing the signal reception from the second electronic device through the data line of the second port.

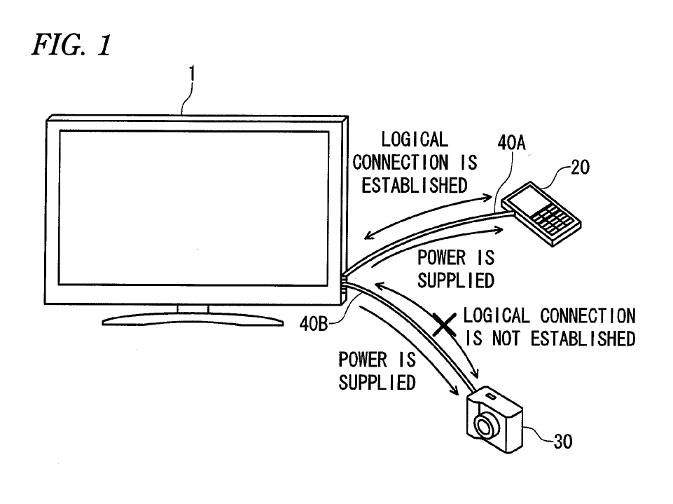

An embodiment will be hereinafter described with reference to FIGS. 1-5. FIG. 1 illustrates a transmission system configured to transmit a signal corresponding to video and/or audio according to the embodiment. The signal transmission system includes a TV receiver 1, a cell phone 20, and a digital camera 30. The cell phone 20 and the digital camera 30 are connected to the TV receiver 1 by cables 40A and 40B, respectively.

The TV receiver 1 is a sink apparatus for receiving a signal corresponding to video and/or audio to display video and/or to sound-output audio. Each of the cell phone 20 and the digital camera 30 is a source apparatus which reproduces a signal corresponding to video and/or audio and outputs it to the sink apparatus. Each of the cables 40A and 40B are compatible with an interface standard which permits only one source apparatus to be logically connected with a sink apparatus. One example of such an interface standard is MHL (mobile high-definition link). In the following description, it is assumed that the cables 40A and 40B are compatible with the MHL standard.

As shown in FIG. 1, if a logical connection is established between the TV receiver 1 and the cell phone 20, the TV receiver 1 cannot establish a logical connection to the digital camera 30. Conventionally, since power is supplied to only a logically connected apparatus, the cell phone 20 is only the source apparatus that is supplied with power from the TV receiver 1. Contrary, in the embodiment, the digital camera 30 which is not connected to the TV receiver 1 logically but physically by the cable 40B can also be supplied with power. In the following, how a second source apparatus is supplied with power in the embodiment will be described.

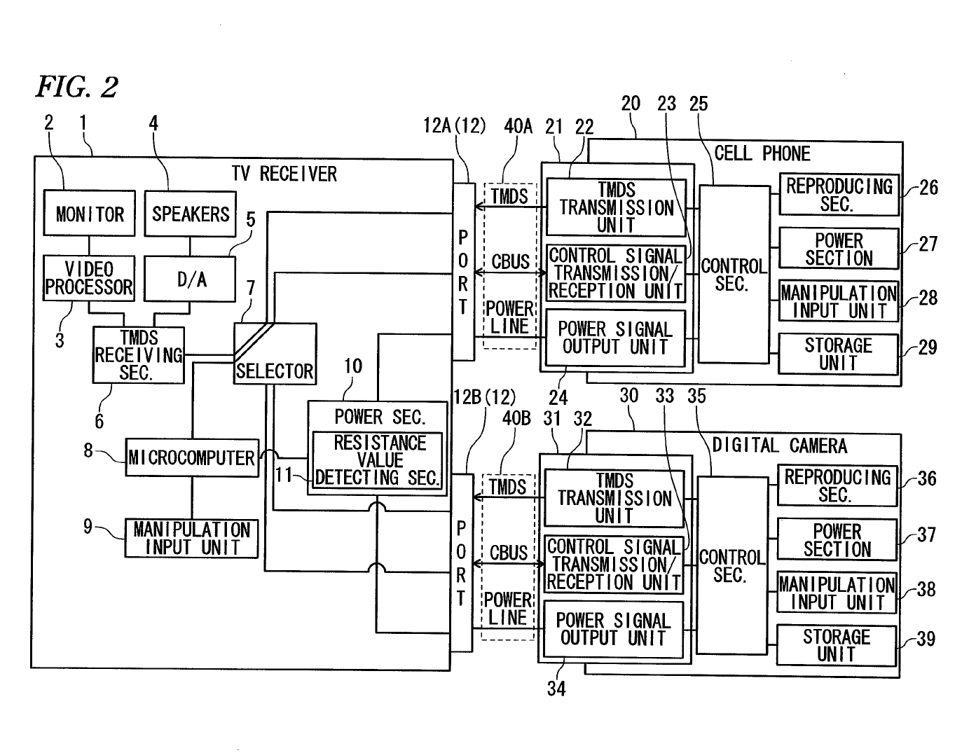

FIG. 2 illustrates a block diagram of the signal transmission system according to the embodiment. First, functions of the TV receiver 1 as a sink apparatus will be described. The TV receiver 1 includes a monitor 2, a video processor 3, speakers 4, a D/A (digital/analog) conversion section 5, a TMDS (transmission minimized differential signaling) receiving section 6, a selector 7, a microcomputer 8, a manipulation input unit 9, a power supply section 10, a resistance value detecting section 11, and ports 12A and 12B.

The monitor 2 displays a video signal as subjected to prescribed video processing in the video processor 3. The speakers 4 outputs an audio signal as subjected to prescribed audio processing in the D/A conversion section 5.

The TMDS receiving section 6 receives a signal corresponding to video and/or audio from the selector 7 and inputs the video signal and/or the audio signal to the video processor 3 and the D/A conversion section 5, respectively.

The selector 7 receives a signal corresponding to video and/or audio from a set port 12 and inputs them to each of the TMDS receiving section 6 and the microcomputer 8.

The microcomputer 8 controls operations of the entire TV receiver 1. The microcomputer 8 performs controls according to a manipulation signal that is input through the manipulation input unit 9 of the TV receiver 1 or from a source apparatus with which a logical connection is established via a port 12. In the embodiment, the microcomputer 8 selects a source apparatus with which a logical connection should be established and determines (a) source apparatus to which power should be supplied.

The manipulation input unit 9 serves for input of a control signal corresponding to a manipulation that is made on a remote controller or the like of the TV receiver 1.

The power supply section 10 supplies power to the individual sections of the TV receiver 1 and each source apparatus that is physically connected to the TV receiver 1 via a port 12. A prescribed voltage is always supplied to each port 12 from the power supply section 10. When a source apparatus is connected to a port 12 by a cable 40, a current flows and a resistance value is detected by the resistance value detecting section 11. The resistance value detected by the resistance value detecting section 11 is input to the microcomputer 8. The microcomputer 8 previously stores a resistance value where a source apparatus is connected to a sink apparatus according to MHL in a memory thereof, and compares the detected resistance value with the stored resistance value to judge whether or not the physical connection with the source apparatus is established via an MHL interface. If judging that the MHL-compatible source apparatus is connected to the port 12, the microcomputer 8 controls the power supply section 10 so that it continues the power supply.

Each input port 12 is an interface for connection to another electronic apparatus and has five pins that are two TMDS pins for transmission of a signal corresponding to video and/or audio, one CBUS pin for transmission of a control signal, one power line pin, and one grounding pin (not shown). Since the shape of each input port 12 can be made the same as that of a micro-USB port, each input port 12 can serve as both of an MHL port and a micro-USB port.

The TV receiver 1 includes the two input ports 12A and 12B.

Next, functions of the cell phone 20 and the digital camera 30 as source apparatus will be described. The cell phone 20 includes an output port 21, a control section 25, a reproducing section 26, a power section 27, a manipulation input section 28, and a storage unit 29. The digital camera 30 includes an output port 31, a control section 35, a reproducing section 36, a power section 37, a manipulation input unit 38, and a storage unit 39. In the embodiment, blocks common to the cell phone 20 and the digital camera 30 will be described and other functions will not be described. In the followings, only the cell phone 20 will be exemplified.

The output port 21 has a TMDS transmission unit 22 for transmission of video, audio, and auxiliary information, a control signal transmission/reception unit 23 for transmission and reception of a control signal, and a power signal output unit 24 for physical connection detection and power supply.

The control section 25 controls operations of the entire cell phone 20.

The reproducing section 26 reproduces content data stored in the storage unit 29.

The power section 27 supplies power to the individual sections of the cell phone 20 and is charged being supplied with power from the TV receiver 1.

The manipulation input unit 28 corresponds to buttons etc. provided in the cell phone 20 and inputs a control signal to the control section 25.

The storage unit 29 is a storage device of the cell phone 20 and stores content data such as photographs and moving images taken.

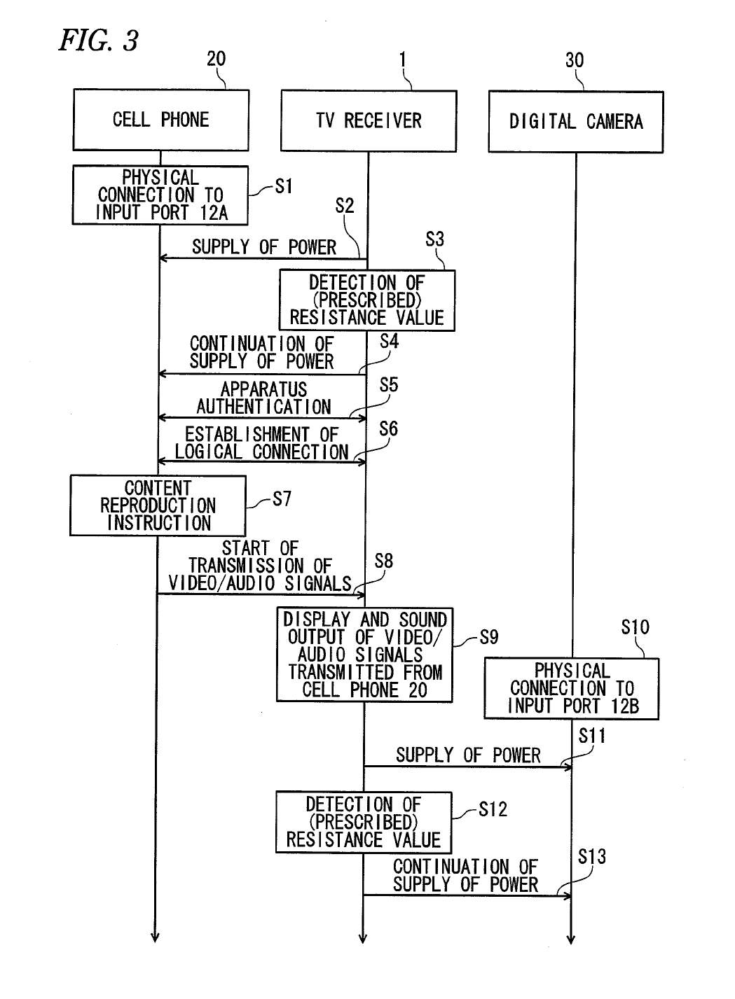

Next, a power control procedure according to the embodiment will be described with reference to FIG. 3. FIG. 3 illustrates a power control according to the embodiment.

First, at step S1, the cell phone 20 is physically connected to the port 12A by the cable 40A. At step S2, the voltage being supplied to the port 12A is output to the cell phone 20 via the cable 40A and a current flows through the power line. At step S3, the resistance value detecting section 11 detects a resistance value of the cell phone 20 based on the current flowing through the port 12A and the output voltage. The microcomputer 8 compares the resistance value detected by the resistance value detecting section 11 with the stored resistance value (i.e., the resistance value prescribed by MHL). If they coincide with each other, the supply of power to the cell phone 20 is continued (step S4).

If judging that one source apparatus is connected to the port 12A based on the resistance value detected by the resistance value detecting section 11, at step S5, the microcomputer 8 performs authentication processing with the connected cell phone 20 using device category information stored in each of the TV receiver 1 and the cell phone 20.

If the authentication succeeds, the microcomputer 8 establishes a logical connection with the cell phone 20. The state that a logical connection is established means a state that signal can be exchanged between the TV receiver 1 and the cell phone 20 via the TMDS lines, the CBUS line, and the power line. In the state that a logical connection is established, the TV receiver 1 can receive video/audio signals of video reproduced by the cell phone 20 via the TMDS lines and display the video on the monitor 2 or the TV receiver 1 and the cell phone 20 can operate in link with each other by exchanging control signals via the CBUS line. Furthermore, the TV receiver 1 can refer to a charging state of the cell phone 20 using control signals exchanged via the CBUS line. The TV receiver 1 can stop the supply of power if judging that the cell phone 20 has been fully charged.

Assume that at step S7 the microcomputer 8 receives a content reproduction instruction from the manipulation input unit 9 or the cell phone 20. At step S8, transmission of a signal corresponding to video and/or audio reproduced by the reproducing section 26 from the TMDS transmission unit 22 is started. At step S9, the transmitted signal corresponding to video and/or audio is received by the TMDS receiving section 6 and displayed and/or sound-output by the monitor 2 and the speakers 3. “VIDEO/AUDIO SIGNALS” in FIG. 3 means “a signal corresponding to video and/or audio”.

Assume that at step S10 the digital camera 30 is physically connected to the port 12B by the cable 40B. At step S11, the voltage being supplied to the port 12B is output to the digital camera 30 via the cable 40B and a current flows through the power line and supply of power to the digital camera 30 is started. At step S12, the resistance value detecting section 11 detects a resistance value of the digital camera 30 based on the current flowing through the port 12B and the output voltage. The microcomputer 8 compares the resistance value detected by the resistance value detecting section 11 with the stored resistance value (i.e., the resistance value prescribed by MHL). If they coincide with each other, the supply of power to the digital camera 30 is continued (step S13). Since the logical connection has already been established with the cell phone 20, the microcomputer 8 does not perform authentication processing with the digital camera 30 and does not try to establish a logical connection therewith. That is, the TV receiver 1 does not communicate with the digital camera 30 via the TMDS lines or the CBUS line unless the logical connection with the cell phone 20 is canceled.

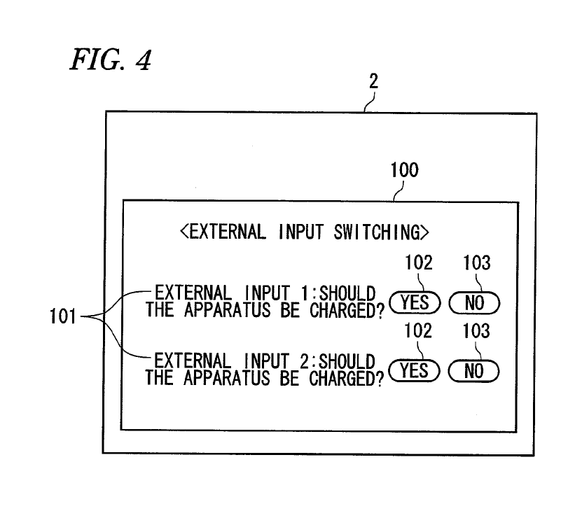

In the above-described example, power is supplied to every physically-connected source apparatuses. However, the TV receiver 1 may provide a user interface as shown in FIG. 4 to allow the user to set whether to supply power to each source apparatus. Information thus set is managed by the microcomputer 8 and stored in the memory. FIG. 4 illustrates an example of an external input switching picture used in the embodiment.

The external input switching picture 100 includes external inputs 101, buttons 102 for selecting charging of respective source apparatus (external input sources) and buttons 103 for selecting non-charging of the respective source apparatus.

The external inputs 101 correspond to the respective input ports 12. In the embodiment, an external input-1 and an external input-2 are the input ports 12A and 12B, respectively. When the user selects one of the external inputs 101, the corresponding external input source is selected as a source apparatus for reproducing video. Furthermore, the user can set whether to charge the source apparatus connected to each input port 12.

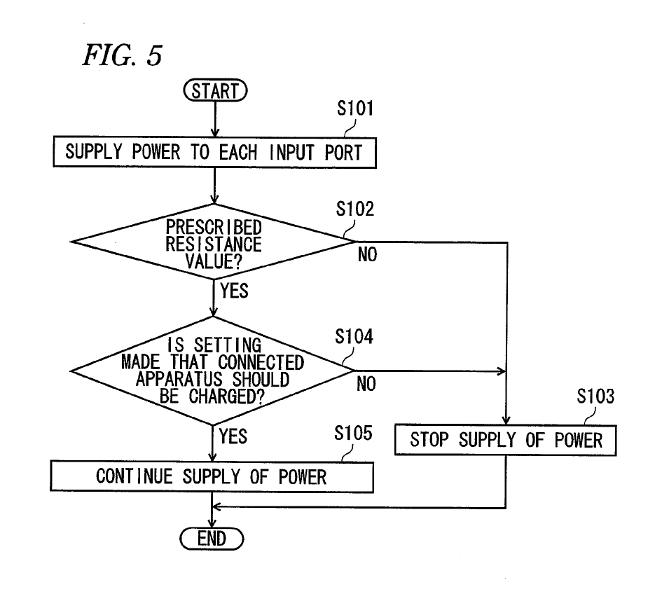

Next, a power control process which is executed by the TV receiver 1 will be described. FIG. 5 illustrates a processing flow of the power control process according to the embodiment.

First, at step S101, the power section 10 output voltages to the respective input ports 12. At step S102, for each input port 12, the microcomputer 8 judges whether or not a resistance value that is detected by the resistance value detecting section 11 based on an output voltage and a current flowing through the power line coincides with the previously-stored resistance value (the resistance value prescribed by MHL). If it is judged that the detected resistance value does not coincide with the prescribed one (S102: no), at step S103 the supply of power to the input port 12 concerned is stopped.

On the other hand, if judging that the detected resistance value coincides with the prescribed one (S102: yes), the microcomputer 8 judges at step S104 whether or not a setting is made that the source apparatus connected to the input port 12 concerned should be charged. If such a setting is not made (S104: no), the process moves to step S103. On the other hand, if such a setting is made (S104: yes), at step S105 the supply of power to the input port 12 concerned is continued. The power control process according to the embodiment is thus finished.

In the above-described embodiment, when plural electronic apparatus are connected to a sink apparatus according to an interface standard which permits only a logically connected electronic apparatus to be charged, an electronic apparatus that is not logically-connected to the sink apparatus can also be charged. More specifically, a physical connection is judged based on a resistance value that is detected from the power line of each input port 12. If a source apparatus is connected to the sink apparatus via the prescribed interface, power can be supplied to the source apparatus even if no logical connection is established. Therefore, even if an interface standard which restricts the number of logically connectible apparatus to one, plural physically connected source apparatus can be charged, thereby improving usability.

The invention is not limited to the above embodiment, and may be embodied by modifying constituent elements without departing from the spirit and scope of the invention. For example, plural constituent elements disclosed in the embodiment may be properly combined, and several ones of the constituent elements may be omitted.

What is claimed is:

1. An electronic apparatus, comprising:
a first port and a second port each comprising:
a data line configured to receive a signal comprising at least one of video data and audio data; and
a power line; and
a controller configured to control the data line and the power line,
wherein, upon connection of a first electronic device to the first port, the electronic apparatus receives the signal from the first electronic device through the data line of the first port and the first electronic device receives power through the power line of the first port, and
wherein, upon connection of a second electronic device to the second port in addition to the connection of the first electronic device to the first port, the second electronic device receives power through the power line of the second port without the electronic apparatus receiving the signal from the second electronic device through the data line of the second port.

2. The apparatus of claim 1,
wherein the first port and the second port each further comprise a control line configured to perform a control signal exchange,
wherein the controller is further configured to perform, upon the physical connection of the first electronic device to the first port, the control signal exchange through the control line of the first port.

3. The apparatus of claim 1, wherein a user sets whether the controller performs the power supply for each of the first electronic device and the second electronic device.

4. A power control method for an electronic apparatus comprising a first port and a second port each comprising a data line and a power line, the method comprising:
performing, upon connection of a first electronic device to the first port, a signal reception from the first electronic device through the data line of the first port and a power supply to the first electronic device through the power line of the first port; and
performing, upon connection of a second electronic device to the second port in addition to the connection of the first electronic device to the first port, a power supply to the second electronic device through the power line of the second port without performing the signal reception from the second electronic device through the data line of the second port.

5. The method of claim 4,
wherein the first port and the second port each further comprises a control line configured to perform a control signal exchange, and
wherein, upon the connection of the first electronic device to the first port, the control line performs the control signal exchange through the first port.

6. The method of claim 4, wherein the user sets, for each of the first electronic device and the second electronic device, whether to perform the power supply through the power line.
